(19) United States
(12) Patent Application Publication
(10) Pub. No.: US 2012/0263240 A1
(43) Pub. Date: Oct. 18, 2012

(54) VIDEO ENCODING AND DECODING DEVICE

(76) Inventors: Tadakazu Kadoto, Kodaira (JP); Masatoshi Kondo, Kodaira (JP); Masaki Hamamoto, Kodaira (JP); Muneaki Yamaguchi, Kodaira (JP)

(21) Appl. No.: 13/510,631

(22) PCT Filed: Oct. 7, 2010
(86) PCT No.: PCT/JP2010/067677

§ 371 Date: Jun. 22, 2012

(30) Foreign Application Priority Data
Nov. 19, 2009 (JP) 2009-264090

(51) Int. Cl. H04N 7/26

(52) U.S. Cl. 375/240.24; 375/E07.075

(57) ABSTRACT

Disclosed is a video encoding and decoding device which encodes images and compresses the information volume in accordance to the standard H.264. In the device, image folding determination processing is performed utilizing the symmetry of an input image, and a block of one area of the input image is set to be a folding area. By setting folding points describing the folding area, only information for the folding area and the folding points is encoded. After decoding, the entire image is restored from the folding area, which was the encoded area, but in areas that cannot be directly restored from the folding area, the image is restored by performing padding from peripheral blocks. By this means, the symmetry of an image is utilized to increase encoding efficiency without degrading image quality.

### BACKGROUND OF THE INVENTION

The present invention relates to a video encoding and decoding device. The invention more particularly relates to a video encoding and decoding device that utilizes the symmetry of image data to enhance an encoding efficiency.

Recently, the amount of data to be transmitted for video images has increased on a daily basis. As one example, the amount of data for an analog television is explained. For a current Japanese standard television, the number of pixels in a horizontal direction is 720, and the number of pixels in a vertical direction is 480. The pixels each have 8-bit luminance data and two color-difference data pieces (8 bits). A video image for one second has 30 images. Currently, a scheme in which the amounts of color components of the luminance data in the horizontal and vertical directions are reduced by half is used. Thus, as the amount of data for one second, 720×480×(8+8×½×½+8×½×½)×30=124416000 bits are necessary, and a transmission rate needs to be approximately 120 Mbps.

Even for an optical fiber that is currently and widely used as a household broadband, however, a transmission rate is approximately 100 Mbps. Thus, it is realistically impossible to transmit a video image unless the video image is compressed. It is said that the amount of data for digital terrestrial broadcasting to which the current broadcasting will be switched in 2011 is 1.5 Gbps. It can be said that a high-efficiency compression technique is a technique that will be necessary in the future.

At present, the technique that is expected to be widely used as a standard for the high-efficiency compression technique is H.264/AVC (hereinafter referred to as H.264). H.264 is the latest international standard (for video image encoding) that has been developed by Joint Video Team (JVT). JVT has been jointly established in December, 2001 by Video Coding Experts Group (VCEG) of International Telecommunication Union Telecommunication Standardization Sector (ITU-T) and MPEG (Moving Picture Expert Group) of International Organization for Standardization (ISO)/International Electrotechnical Commission (IEC).

H.264 was approved by ITU-T in May, 2003 as a recommendation. In addition, H.264 was standardized by ISO/IEC Joint Technical Committee 1 (JTC 1) in 2003 as MPEG-4 Part 10 Advanced Video Coding (AVC). Further, an expansion task that is related to a color space and gradations of pixels was performed. The final plan for the standard was created by Fidelity Range Extension (FRExt) in July, 2004.

Main features of H.264 are as follows.
With an encoding efficiency that is approximately twice as high as conventional schemes such as MPEG-2 and MPEG-4, an image quality that is the same as or similar to the conventional schemes can be achieved.
Compression algorithm: an inter-frame prediction, quantization and an entropy code are used.
Can be used with bit rates from a low bit rate for mobile phones or the like to a high bit rate for high-definition televisions or the like.

It should be noted that details of H.264 are described in http://ja.wikipedia.org/wiki/H.264, which is an URL of Wikipedia (free encyclopedia).

Hereinafter, encoding, which is performed according to H.264 that is the latest video image encoding standard, is described as Background with reference to FIGS. 11 and 12.

FIG. 11 is a diagram illustrating the configuration of a general H.264 encoder.

FIG. 12 is a diagram illustrating a concept of an inter-frame prediction.

According to H.264, an intra prediction 104 and an inter prediction 105 are stipulated. The intra prediction 104 generates a predicted image a frame, and the inter prediction 105 generates a predicted image between frames. Here, differences between the generated predicted images and the original image are obtained. As illustrated in FIG. 11, orthogonal transform 102 and quantization 103 are performed on data of the differences. Thereafter, encoding 110 such as variable-length coding is performed on the quantized data. According to H.264, a high encoding efficiency is achieved by encoding only a difference image and transmitting the encoded difference image.

The intra prediction is a process of generating a predicted image using a correlation between adjacent pixels. In the intra prediction, the predicted image is generated on the basis of a correlation between a pixel to be predicted and a pixel located around the pixel to be predicted, and a pixel that is located on the upper right side with respect to the left side of a block to be predicted is used. As illustrated in FIG. 12, the inter prediction is a process of generating a predicted image from frames 200 and 202 preceding and succeeding an input image 201 to be predicted. The inter prediction is a process of calculating a motion vector of a pixel (to be predicted) from the preceding and succeeding frames, and generating the predicted image. As described above, according to H.264 that is the latest video image encoding standard, the various methods are used in order to achieve a high-efficiency compression technique.

In general, when a transmission rate is high, encoding is performed on data corresponding to the size of an input image in a video image encoding process. On the other hand, when the transmission rate is low, a pre-filter process is performed on a video format of the input image to change the size of the image so that the input image is encoded. This process is to change the sizes of all input images to a certain size.

As described above, when the transmission rate is low and the size of the image is to be changed, downsampling is performed in a horizontal direction or a vertical direction in general. When image data is downsampled, however, it is inevitable to degrade the quality of the image to some extent. In a general encoding method according to H.264, encoding is performed without utilizing the symmetry of the image. Thus, all parts of the image are encoded even when the image is bilaterally symmetric, and the encoding efficiency is not necessarily high.

The present invention was devised in order to solve the aforementioned problems, and an object of the present invention is to provide a video encoding and decoding device that encodes an image, compresses an information volume, utilizes the symmetry of the image and improves the encoding efficiency without degrading image quality.

### SUMMARY OF THE INVENTION

According to the present invention, image folding determination processing is performed utilizing the symmetry of an input image, and a block of one area of the input image is set to be a folding area. By setting folding points describing the folding area, only information of the folding area and the folding points is encoded.

Thus, an area to be encoded can be reduced, and the size of the image to be encoded can be changed to an arbitrary size.

After decoding, the entire image is restored from the folding area, which was the encoded area. In areas that cannot be directly restored from the folding area, however, the image is restored by performing padding from peripheral blocks.

### BRIEF DESCRIPTION OF DRAWINGS

FIG. 1 is an outline diagram illustrating a process that is performed by an encoder that is included in a video encoding and decoding device according to an embodiment of the present invention.

FIG. 2 is a diagram illustrating the configuration of the encoder that is included in the video encoding and decoding device according to the embodiment of the present invention.

FIG. 3 is a diagram explaining a case in which block numbers are added to an image in folding determination processing.

FIG. 4 is a diagram (first diagram) explaining setting of folding points in the folding determination processing.

FIG. 5 is a diagram (second diagram) explaining setting of folding points in the folding determination processing.

FIG. 6 is a diagram (first diagram) explaining the folding determination processing.

FIG. 7 is a diagram (second diagram) explaining the folding determination processing.

FIG. 8 is a diagram illustrating an example of a stream after encoding according to the present invention.

FIG. 9 is a diagram illustrating the configuration of a decoder that is included in the video encoding and decoding device according to the embodiment of the present invention.

FIG. 10 is a diagram explaining folding processing.

FIG. 11 is a diagram illustrating the configuration of a general H.264 encoder.

FIG. 12 is a diagram explaining a concept of an inter prediction according to H.264.

### DESCRIPTION OF THE PREFERRED EMBODIMENT

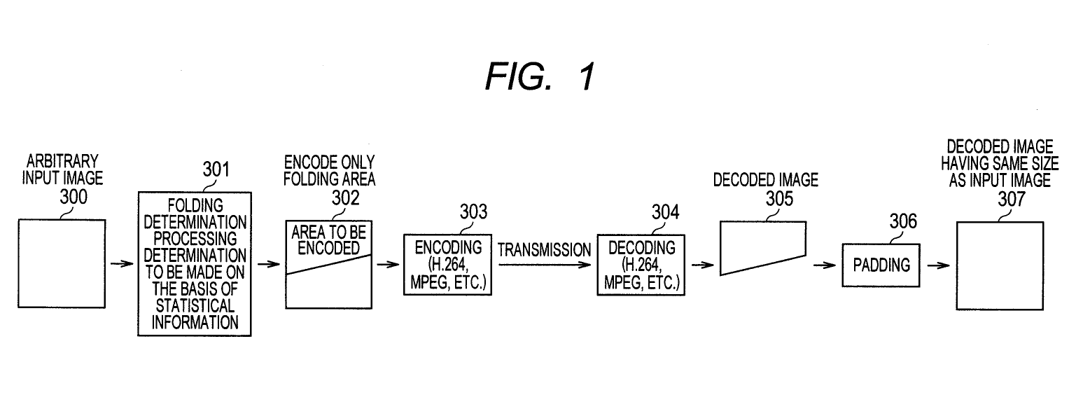

Hereinafter, an embodiment of the present invention is described with reference to FIGS. 1 to 10.

The embodiment of the present invention is described using a configuration in which H.264 that is the latest video image encoding standard is applied to the present invention.

First, an outline of a process that is performed by an encoder included in a video encoding and decoding device according to the embodiment of the present invention is described with reference to FIG. 1.

FIG. 1 is an outline diagram illustrating the process that is performed by the encoder included in the video encoding and decoding device according to the embodiment of the present invention.

As illustrated in FIG. 1, in the process that is performed by the encoder included in the video encoding and decoding device according to the embodiment of the present invention, folding determination processing 301 is performed on an input image utilizing the symmetry of the input image, a block of one area of the input image is treated as a folding area, folding points that describe the folding area are set, and encoding 302 is performed to encode only the folding area and the folding points. The folding points and the folding area are described in detail later. Thus, an area to be encoded can be reduced, and the size of the image to be subjected to the encoding 302 can be arbitrarily changed. By performing padding 306 after decoding 304, an image 307 whose size is the same as the size of the input image is restored.

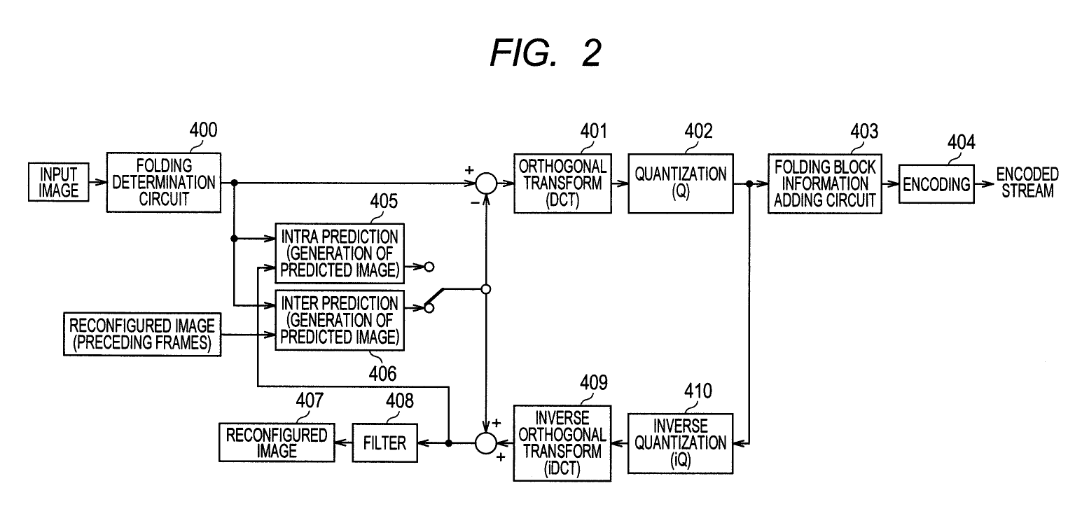

First, the configuration of the encoder that is included in the video encoding and decoding device according to the embodiment of the present invention is described with reference to FIG. 2.

FIG. 2 is a diagram illustrating the configuration of the encoder that is included in the video encoding and decoding device according to the embodiment of the present invention.

The encoder of the video encoding and decoding device according to the embodiment of the present invention is configured by adding a folding determination circuit 400 and a folding block information adding circuit 403 to a general H.264 encoder, as illustrated in FIG. 2. In the present embodiment, the folding determination circuit 400 determines whether or not the input image can be folded. When the input image can be folded, only a folding area of the input image is encoded. Then, folding block information is added to quantized coefficient data subjected to the quantization 402.

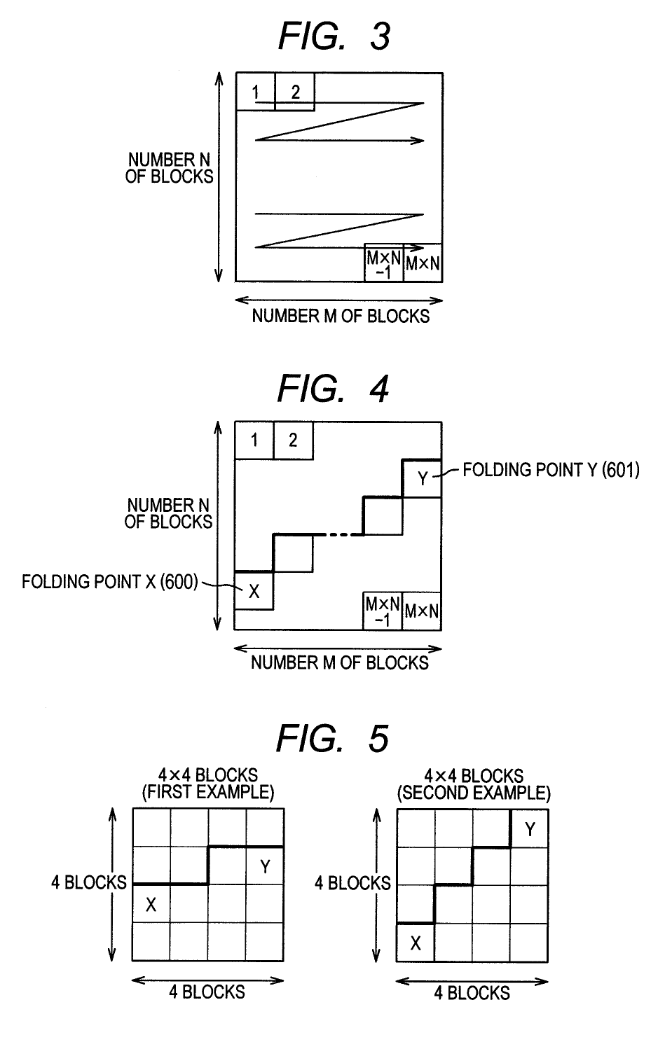

Next, details of the process that is performed by the encoder included in the video encoding and decoding device according to the embodiment of the present invention are described with reference to FIGS. 3 to 8.

FIG. 3 is a diagram explaining that block numbers are added to the image in the folding determination processing.

FIGS. 4 and 5 are diagrams explaining setting of folding points in the folding determination processing.

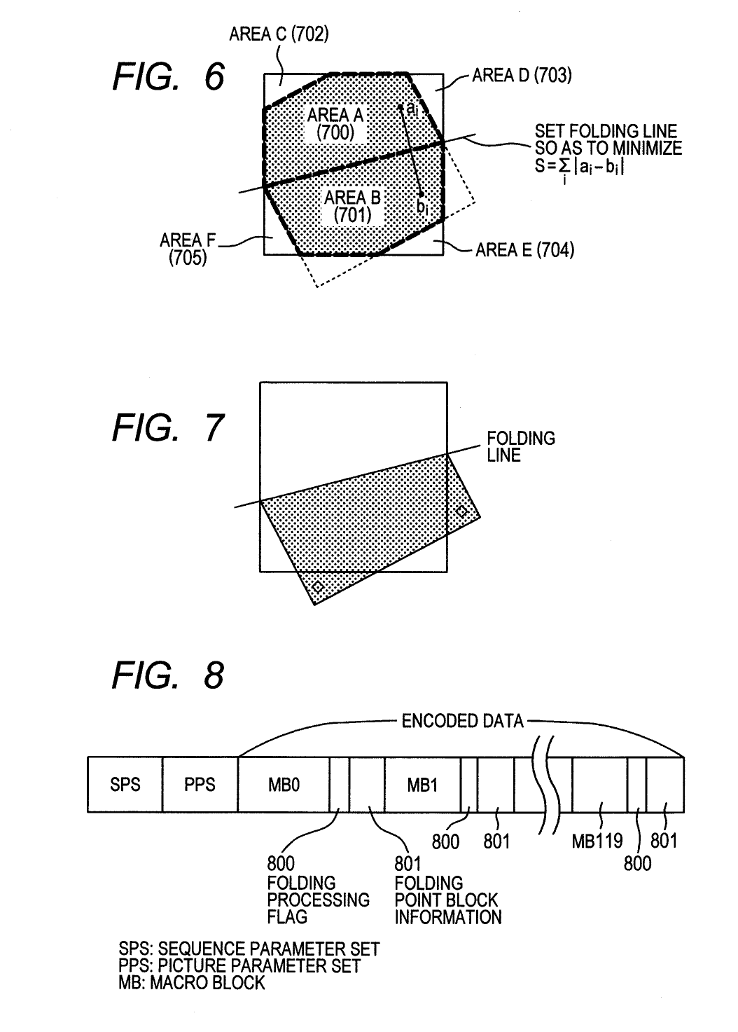

FIGS. 6 and 7 are diagrams explaining the folding determination processing.

FIG. 8 is a diagram illustrating an example of a stream after the encoding according to the present invention.

Hereinafter, steps 1 to 5 of the process to be performed by the encoder are described.

(Step 1) First, as illustrated in FIG. 3, block numbers are added to an input image that has M×N blocks (M and N are arbitrary numbers).

(Step 2) Next, as illustrated in FIG. 4, a folding point X (600) and a folding point Y (601) are searched. The folding points are two blocks that are specified so that a folding line can be set in the image. As illustrated in FIG. 5, the folding line is set so that the amounts of changes from a block position of X to a block position of Y are equal.

In this case, as illustrated in FIG. 6, the folding determination is made using a gradient method or the like so that the sum of absolute differences between pixel values of an area A (700) and pixel values of an area B (701) is minimized.

Specifically, the folding line is set so that a folding error S of the following Equation (1) is minimized.

$$S = {\sum }_{i}^{ } \vert {a}_{i} - {b}_{i} \vert \qquad [ Equation 1 ]$$

A symbol aᵢ is a pixel value of the area A, and a symbol bᵢ is a pixel value of the area B. A pixel with the pixel value aᵢ and a pixel with the pixel value bᵢ are located symmetrically about the folding line. The sigma Σ is the sum of absolute differences between all pixels of the area A and all pixels of the area B.

An area that is among two areas divided by the folding line and has a larger area than the other area is treated as a folding area. In FIG. 6, the area A (700), an area C (702) and an area D (703) are folding areas, for example.

(Step 3) When the folding error is equal to or smaller than an arbitrarily set threshold, only the folding areas (for example, area A (700), area C (702) and area D (703)) are extracted, and post-processes that are orthogonal transform 401 and quantization 402 are performed on the extracted folding areas. When the folding error is larger than the threshold, the input image is not extracted and the post-processes are performed.

The arbitrarily set threshold that is used to determine whether or not a folding area is extracted may be set on the basis of a statistical decision or a transmission rate.

(Step 4) A folding processing flag 800 and block information of the folding points (600/601) are added to the quantized data as folding point block information 801. The folding processing flag 800 is used to determine whether or not a folding area is being extracted from the quantized data in Step 3.

(Step 5) Encoding such as variable-length coding is performed.

As illustrated in FIG. 8, an encoded stream is configured by adding the folding processing flag 800 and the folding point block information 801 to encoded macro block data pieces MBi (i=0, . . . , (the number of the macro block data pieces)−1), for example. When the folding processing flag 800 indicates that a folding area is not extracted, the folding point block information 801 is omitted.

The folding processing flag 800 and the folding point block information 801 are added to all the encoded macro block data pieces MBi in order to perform the process at a high speed.

In Step 4, by adding the necessary information to the quantized data, it is possible to prevent information of folding block numbers from being lost or having a rounding error due to a quantization error. In addition, since necessary information on the folding can be multiplexed into video image data to be transmitted, there is an advantage that an additional transmission path does not need to be provided.

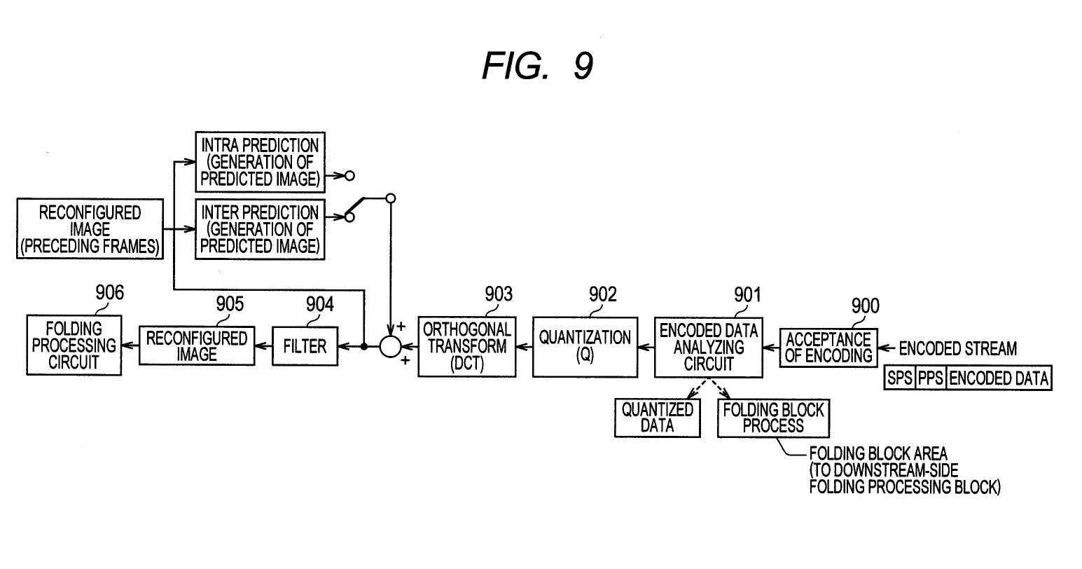

Next, the configuration of a decoder that is included in the video encoding and decoding device according to the embodiment of the present invention is described with reference to FIG. 9.

FIG. 9 is a diagram illustrating the configuration of the decoder that is included in the video encoding and decoding device according to the embodiment of the present invention.

The decoder that is included in the video encoding and decoding device according to the embodiment of the present invention is configured by adding a decoded data separation circuit 901 and a folding processing circuit 906 to a general H.264 decoder. The decoder performs a process in an inverse manner with the process to be performed by the encoder so that the input image is restored.

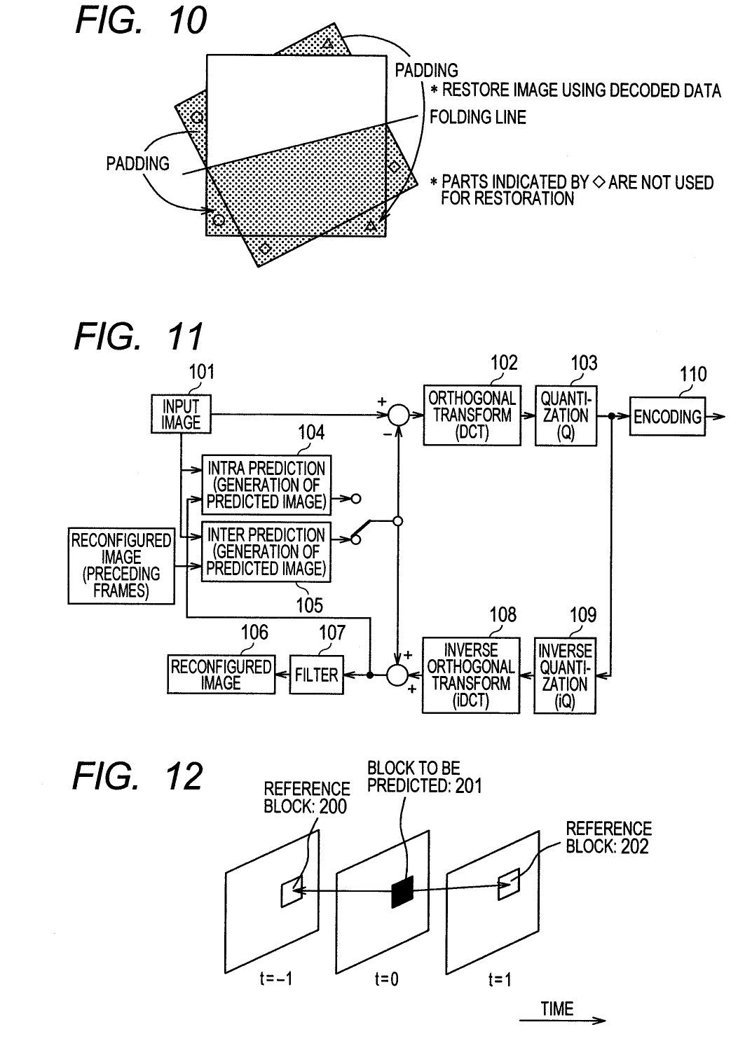

Next, details of the process to be performed by the decoder included in the video encoding and decoding device according to the embodiment of the present invention are described with reference to FIG. 10.

FIG. 10 is a diagram explaining the folding processing.

Steps 5 to 7 of the process to be performed by the decoder are described.

(Step 5) First, decoding 900 is performed.

(Step 6) Next, the decoded data separation circuit 901 extracts the folding block information from decoded data and transmits the extracted information to the folding processing circuit 906. In addition, the quantization coefficient data other than the extracted data is subjected to inverse quantization 902 and post-processes.

(Step 7) Next, the folding processing is performed on a reconfigured image 905 decoded from inversely orthogonally transformed data and predicted image data on the basis of the folding block information transmitted from the decoded data separation circuit 901 so that the image is restored.

Next, details of the folding processing performed in Step 7 are described. As illustrated in FIG. 10, the folding processing is to restore other areas that are not encoded (an area B (700), an area E (704) and an area F (705) in this example) on the basis of a decoded image of the folding areas encoded on the basis of the folding block information.

When the image data is folded in the folding processing and thus some areas of the input image extend beyond the size of the input image, data on such extending areas (parts indicated by diamond symbols) of the input image is not used to restore the data.

Thus, parts (parts indicated by circle symbols and triangle symbols, areas E (704) and F (705) in FIG. 6) that cannot be restored by the folding processing exist, as illustrated in FIG. 10. The parts that cannot be restored by the folding processing are subjected to padding utilizing the symmetry of a decoded image of a processed peripheral block and thereby restored.

Alternatively, the parts (parts indicated by circle symbols and triangle symbols) that cannot be restored by the folding processing are encoded in accordance with the determination processes in a normal manner and transmitted from the encoder.

The above determination processes are as follows:
(1) The encoder makes this determination by calculating errors (sums of differences between pixel values) between areas (indicated by circle symbols and triangle symbols and corresponding to each other) of peripheral blocks for the areas necessary to be subjected to the padding, and it is determined that the errors are larger than a certain threshold; or
(2) It is determined that there is no block located around an interested block, for example, when the interested block is located at an edge of the image.

In this case, the padding can be achieved by adding a flag indicating whether or not the parts subjected to the padding are transmitted to block information to be added to the encoded data.

In the encoding of Step 5, a reconfigured image holds only the folding areas. In this case, when an area other than the folding areas is referenced in the intra prediction or the inter prediction, the folding processing is performed so that another area is restored.

According to the present embodiment, since the size of the input image is changed to an arbitrary size, information can be fed back for control of the amount of data to be encoded and generated, and the quality of the image can be improved. Especially, the video encoding and decoding device according to the present embodiment can obtain an effect of significantly improving the efficiency of encoding an input image that has symmetry. When an image has symmetry and is complex, the amount of the input image to be transmitted can be reduced. It is, therefore, possible to prevent the quality of the image from being degraded due to a quantization error.

Whether or not the process is performed by the video encoding and decoding device according to the present invention can be determined by analyzing the stream since the size of the input image is different from a conventional technique.

According to the present invention, the video encoding and decoding device that encodes an image and thereby compresses the amount of information can be provided, which uses the symmetry of the image and improves the encoding efficiency without degrading image quality.

### EXPLANATION OF NUMERALS

101 . . . Input image, 102 . . . Orthogonal transform, 103 . . . Quantization, 104 . . . Intra prediction, 105 . . . Inter prediction, 106 . . . Reconfigured image, 107 . . . Filter, 108 . . . Inverse orthogonal transform, 109 . . . Inverse quantization, 110 . . . Encoding,

400 . . . Folding determination circuit, 401 . . . Orthogonal transform, 402 . . . Quantization, 403 . . . Folding block information adding circuit, 404 . . . Encoding, 405 . . . Intra prediction, 406 . . . Inter prediction, 407 . . . Reconfigured image, 408 . . . Filter, 409 . . . Inverse orthogonal transform, 410 . . . Inverse quantization,

901 . . . Encoded data analyzing circuit, 902 . . . Quantization, 903 . . . Orthogonal transform, 904 . . . Filter, 905 . . . Reconfigured image, 906 . . . Folding processing circuit

What is claimed is:

1. A video encoding and decoding device that encodes a video image for each of pixel blocks,
wherein an input image is divided into the pixel blocks and, based on the symmetry of pixel values of the input image, the input image is sectioned to have two areas each including the divided pixel blocks, and
wherein one of the two areas is specified as an area to be encoded, with information in one of the two areas being encoded.

2. The video encoding and decoding device according to claim 1,
wherein when pixel values of the area not to be encoded are restored on the basis of pixel values of the area to be encoded, pixel blocks of the area not to be encoded are sectioned into a first area and a second area, the first area being highly symmetric with corresponding pixel blocks of the area to be encoded, a second area being not highly symmetric with the corresponding pixel blocks of the area to be encoded,
wherein pixel values of the first area are restored on the basis of pixel values of the corresponding pixel blocks of the area to be encoded, and
wherein pixel values of the second area are restored on the basis of pixel values of a corresponding area of pixel blocks located around interested pixel blocks.

3. The video encoding and decoding device according to claim 2,
wherein when the input image is encoded, it is determined whether or not an area that corresponds to a pixel block located around the second area exists, and
wherein when the area that corresponds to the pixel block located around the second area does not exist, or when the sum of differences between pixel values of the second area and pixel values of an area corresponding to pixel blocks located around pixel blocks including the second area is calculated and larger than a certain threshold, the second area is encoded.
